(19) United States
(12) Patent Application Publication
(10) Pub. No.: US 2025/0159410 A1
(43) Pub. Date: May 15, 2025

(54) ELECTROACOUSTIC TRANSDUCER AND HEADPHONE

(71) Applicant: AUDIO-TECHNICA CORPORATION, Tokyo (JP)

(72) Inventor: Daisuke YONEYAMA, Tokyo (JP)

(21) Appl. No.: 19/020,113

(22) Filed: Jan. 14, 2025

Related U.S. Application Data
(63) Continuation of application No. PCT/JP2023/025905, filed on Jul. 13, 2023.

(30) Foreign Application Priority Data
Aug. 2, 2022 (JP) 2022-123374

(51) Int. Cl. H04R 7/12; H04R 1/10; H04R 7/18; H04R 9/06

(52) U.S. Cl. CPC H04R 7/122; H04R 1/10; H04R 7/127; H04R 7/18; H04R 9/06

(57) ABSTRACT

An electroacoustic transducer includes: a diaphragm that has a main dome disposed on the central part, and a sub dome that annularly surrounds the main dome, with inner and outer circumferences each forming a circle of a predetermined radius; a support part that fixedly supports an outer peripheral edge of the sub dome; and a voice coil that is provided on the back side of the diaphragm and vibrates the diaphragm. The sub dome has a plurality of first vertices and a plurality of second vertices, which differ in at least one of (i) a distance from the outer peripheral edge in the radial direction and (ii) a position in the height direction, and are located at predetermined intervals in the circumferential direction. The plurality of first vertices and the plurality of second vertices are located on an annular curved surface that is continuous in the circumferential direction.

### CROSS-REFERENCE TO RELATED APPLICATIONS

The present application is a U.S. National Stage entry of PCT Application number PCT/JP2023/25905, filed on Jul. 13, 2023, which claims priority under 35 U.S.C § 119 (a) to Japanese Patent Application No. 2022-123374, filed on Aug. 2, 2022, contents of which are incorporated herein by reference in their entirety.

### BACKGROUND OF THE INVENTION

The present disclosure relates to an electroacoustic transducer and a headphone. An electroacoustic transducer provided in a headphone or the like includes a diaphragm vibrated by a voice coil. The diaphragm has a main dome disposed on the central part and a sub dome surrounding the main dome. In order to achieve full-range sound reproduction, for example, the electroacoustic transducer vibrates the diaphragm in a piston motion mode during low-frequency reproduction, and vibrates the diaphragm in a divided vibration mode during high-frequency reproduction.

The above-described divided vibrations occur mainly in the sub dome. Therefore, it is known that when the diaphragm is vibrated in the divided vibration mode, peaks and dips occur in the vicinity of the natural frequency of the sub dome. In order to suppress the influence of the divided vibrations, an approach of using a sound absorbing material, an acoustic resistance material, or the like, or a method of adopting a material with high internal loss for the diaphragm can be considered, but when such an approach is used, a significant negative effect (such as deterioration of sound quality) occurs alongside improvement of divided vibrations.

### BRIEF SUMMARY OF THE INVENTION

The present disclosure focuses on these matters, and its object is to suppress the occurrence of peaks and dips due to divided vibrations, without deterioration of sound quality.

A first aspect of the present disclosure provides an electroacoustic transducer including: a diaphragm that has a main dome disposed on a central part, and a sub dome that annularly surrounds the main dome, with inner and outer circumferences each forming a circle of a predetermined radius; a support part that fixedly supports an outer peripheral edge of the sub dome; and a voice coil that is provided on a back side of the diaphragm and vibrates the diaphragm, wherein the sub dome has a plurality of first vertices and a plurality of second vertices, which differ in at least one of (i) a distance from the outer peripheral edge in a radial direction and (ii) a position in a height direction, and are located at predetermined intervals in a circumferential direction, and the plurality of first vertices and the plurality of second vertices are located on an annular curved surface that is continuous in the circumferential direction.

A second aspect of the present disclosure provides a headphone including the electroacoustic transducer described above.

### BRIEF DESCRIPTION OF THE DRAWINGS

FIG. 1 is a schematic diagram illustrating a configuration of an electroacoustic transducer 10 according to one embodiment.

FIG. 2 is a schematic view for explaining a headphone 1.

FIG. 3 is a schematic view for explaining a planar configuration of a diaphragm 16 according to a first embodiment.

FIG. 4 is a schematic perspective view of the diaphragm 16.

FIG. 5A is a schematic view for explaining a cross-sectional configuration of a sub dome 24.

FIG. 5B is a schematic view for explaining a cross-sectional configuration of a sub dome 24.

FIG. 6 is an explanatory view for explaining the effect of the shape of the sub dome 24.

FIG. 7 is a schematic view for explaining the configuration of a diaphragm 16 according to the second embodiment.

FIG. 8A is a schematic view for explaining a cross-sectional configuration of a sub dome 24 according to a second embodiment.

FIG. 8B is a schematic view for explaining a cross-sectional configuration of a sub dome 24 according to a second embodiment.

FIG. 9A is a schematic view for explaining a cross-sectional configuration of a sub dome 24 according to a third embodiment.

FIG. 9B is a schematic view for explaining a cross-sectional configuration of a sub dome 24 according to a third embodiment.

FIG. 10 is a schematic diagram for explaining the configuration of the diaphragm 16 according to a fourth embodiment.

### DETAILED DESCRIPTION OF THE INVENTION

Hereinafter, the present disclosure will be described through exemplary embodiments, but the following exemplary embodiments do not limit the disclosure according to the claims, and not all of the combinations of features described in the exemplary embodiments are necessarily essential to the solution means of the disclosure.

### <Configuration of an Electroacoustic Transducer>

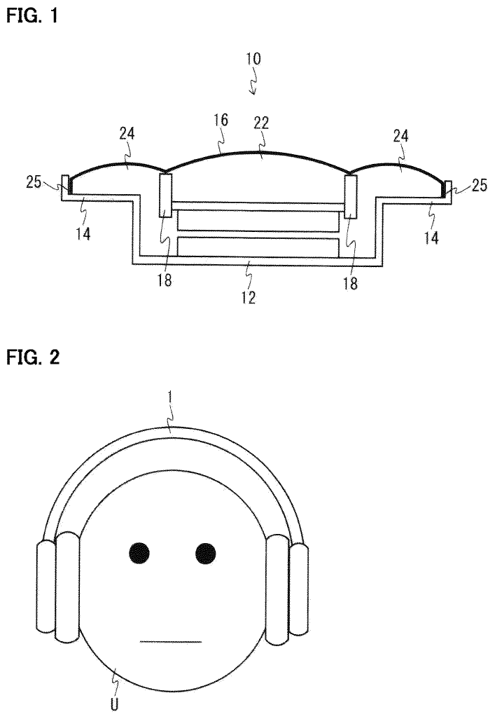

A configuration of an electroacoustic transducer according to one embodiment will be described with reference to FIGS. 1 and 2.

FIG. 1 is a schematic diagram illustrating a configuration of an electroacoustic transducer 10 according to one embodiment. FIG. 2 is a schematic view for explaining a headphone 1. The electroacoustic transducer 10 is a driver unit mounted in the headphone 1 shown in FIG. 2. The headphone 1 is equipment in which devices that convert an electrical signal output from a playback device or a receiver into sound waves using a sound generator near the ear of a user U are combined. The electroacoustic transducer 10 may also be mounted in, for example, an earphone instead of the headphone 1.

As shown in FIG. 1, the electroacoustic transducer 10 includes a yoke 12, a flange part 14, a diaphragm 16, and a voice coil 18.

The yoke 12 is formed in a bottomed cylindrical shape. A magnet is disposed inside the yoke 12. The flange part 14 is formed in an annular shape on an outer peripheral surface of the yoke 12. The flange part 14 functions as a support part that supports the outer peripheral edge of the diaphragm 16.

The diaphragm 16 vibrates to emit sound waves into the air. The diaphragm 16 is made of a very thin and light material so as to vibrate at high speed. The diaphragm 16 tends to vibrate in a piston motion mode during low-frequency reproduction, and tends to vibrate in a divided vibration mode during high-frequency reproduction. As shown in FIG. 1, the diaphragm 16 has a main dome 22 and a sub dome 24.

The main dome 22 is formed in a hemispherical shape, and is disposed on the central part of the diaphragm 16. The sub dome 24 annularly surrounds the main dome 22. The sub-dome 24 forms a ring shape, with the inner and outer circumferences being circles of a predetermined radius. As shown in FIG. 1, the inner circumference of the sub dome 24 is connected to the main dome 22. An outer peripheral edge 25 of the sub dome 24 is fixedly supported by the flange part 14.

The voice coil 18 has a function of converting audio signals into vibrations. The voice coil 18 is provided on the back side of the diaphragm 16 and vibrates the diaphragm 16. The voice coil 18 is in contact with a connecting part between the main dome 22 and the sub dome 24. The voice coil 18 vibrates the diaphragm 16 in order to achieve full-range sound reproduction.

Divided vibrations are mainly generated in the sub dome 24. Therefore, it is known that when the diaphragm is vibrated in the divided vibration mode, peaks and dips occur in the vicinity of the natural frequency of the sub dome 24 (particularly, in the high frequency range).

In order to suppress the influence of the divided vibrations, an approach has been considered of adopting a material with high internal loss for the diaphragm 16 or of adopting sound absorbing materials, acoustic resistance materials, or the like, but a significant negative effect (such as deterioration of sound quality) occurs alongside improvement of the divided vibrations. Specifically, when materials with high internal loss, such as paper, polyurethane, liquid crystal polymer are used for the diaphragm 16, it is possible to expect suppression of peaks and dips, but this would compromise so-called transience, sound sharpness, and sense of speed because sound transmission characteristics become decreased. In addition, when low-resilience urethane is used as the sound absorbing material inside a housing of the headphone 1, it is possible to expect suppression of peaks and dips, but this would compromise the transience, sound sharpness, and sense of speed. Furthermore, when the acoustic resistance material is attached to the front surface of the diaphragm 16, while suppression of peaks and dips can be expected, sound quality becomes dull, and clarity would be lost.

In contrast, in the present embodiment, by devising the surface shape of the sub dome 24 of the diaphragm 16, it is possible to suppress the occurrence of peaks and dips due to the divided vibrations, without deterioration of sound quality, as will be described in detail later.

### <Detailed Configuration of the Diaphragm>

Hereinafter, a detailed configuration of the sub dome 24 of the diaphragm 16 will be described by taking a plurality of embodiments as examples.

### First Embodiment

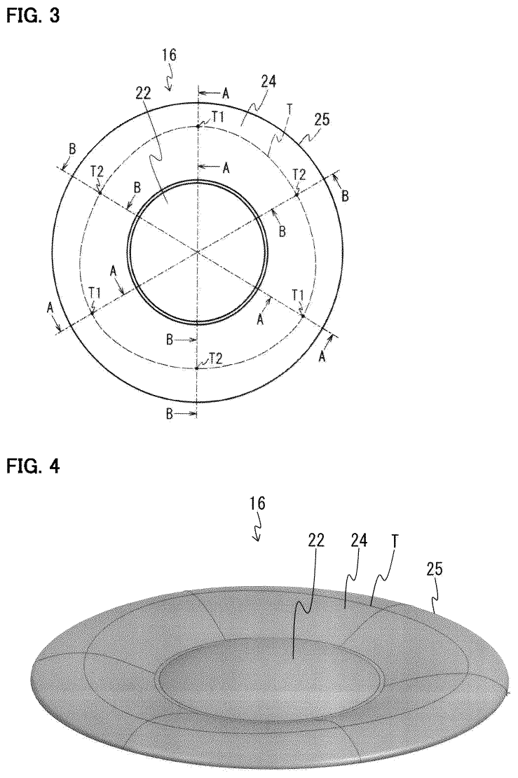

First, a detailed configuration of a sub dome 24 according to a first embodiment will be described with reference to FIGS. 3, 4, 5A and 5B.

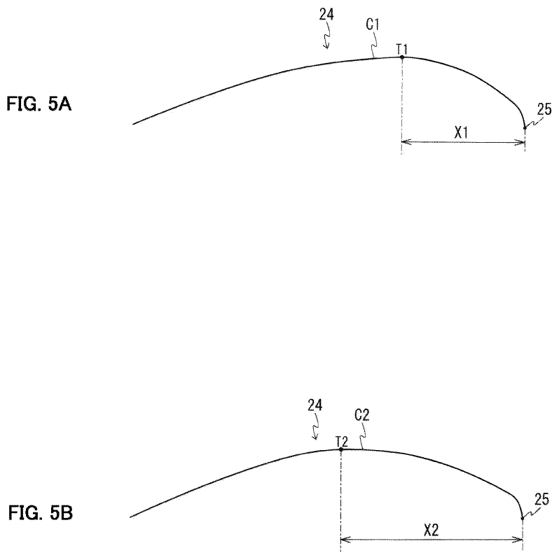

FIG. 3 is a schematic view for explaining a planar configuration of a diaphragm 16 according to the first embodiment. FIG. 4 is a schematic perspective view of the diaphragm 16. FIGS. 5A and 5B are each a schematic view for explaining a cross-sectional configuration of the sub dome 24. FIG. 5A shows a schematic configuration of a cross section A-A of FIG. 3, and FIG. 5B shows a schematic configuration of a cross section B-B of FIG. 3.

As shown in FIG. 3, the sub dome 24 is formed to extend all the way around the outside of the main dome 22. The sub dome 24 is formed such that its curved cross sections are continuous along the circumferential direction. That is, as shown in FIG. 4, the surface of the sub dome 24 is smoothly connected in the circumferential direction, with no portions of steep unevenness on the surface.

In FIG. 3, positions of vertices of the sub dome 24 are indicated by a dashed line T. The vertices indicated by the dashed line T are located on an annular curved surface that is continuous in the circumferential direction. As seen in FIG. 3, the positions of the vertices in the radial direction, indicated by the dashed line T, vary in the circumferential direction. On the other hand, the heights of the vertices indicated by the dashed line T are the same in the circumferential direction.

Among the vertices of the sub dome 24, a first vertex T1 has the shortest distance from the outer peripheral edge 25 of the sub dome 24 in the radial direction, and a second vertex T2 has the longest distance from the outer peripheral edge 25 of the sub dome 24 in the radial direction. Specifically, the distance from the outer peripheral edge 25 to the first vertex T1 is X1, as shown in FIG. 5A, and the distance from the outer peripheral edge 25 to the second vertex T2 is X2, as shown in FIG. 5B. In this way, the sub dome 24 has a plurality of first vertices T1 and second vertices T2, each having different distances from the outer peripheral edge 25 in the radial direction. The heights of the first vertex T1 and the second vertex T2 are the same.

The distances from the outer peripheral edge 25 of the vertices between the first vertex T1 and the second vertex T2 in the circumferential direction continuously change along the circumferential direction, and are greater than X1 and less than X2. Since the sub dome 24 has the plurality of vertices with different distances from the outer peripheral edge 25, as described above, the cross-sectional configuration (in other words, the surface shape) of the sub dome 24 changes along the circumferential direction, causing the natural frequency to vary across different portions of the sub dome 24, which disperses the resonance frequency of the sub dome 24. Consequently, the occurrence of peaks and dips in the high frequency range of the sub dome 24 can be suppressed.

The plurality of first vertices T1 and the plurality of second vertices T2 are located at predetermined intervals in the circumferential direction of the diaphragm 16. Specifically, the first vertices T1 are located at intervals of 120 degrees in the circumferential direction. Similarly, the second vertices T2 are also located at intervals of 120 degrees in the circumferential direction. The first vertices T1 and the second vertices T2 are alternately located at equal angular intervals in the circumferential direction. Specifically, as shown in FIG. 3, three first vertices T1 and three second vertices T2 are alternately located at intervals of 60 degrees.

FIG. 5A illustrates a first curved contour C1 that includes the first vertex T1 of the sub dome 24. The first curved contour C1 is the surface contour of the sub dome 24 in a first cross section obtained by cutting the sub dome 24 along a first surface that is parallel to the radial direction and the height direction of the diaphragm 16. Said first surface passes through the center of the diaphragm 16 and the first vertex T1. As seen in FIG. 5A, the first curved contour C1 is continuously connected without any unevenness in the radial direction.

FIG. 5B illustrates a second curved contour C2 that includes the second vertex T2 of the sub dome 24. The second curved contour C2 is the surface contour of the sub dome 24 in a second cross section obtained by cutting the sub dome 24 along a second surface that is parallel to the radial direction and the height direction of the diaphragm 16. Said second surface passes through the center of the diaphragm 16 and the second vertex T2, and is rotated by a predetermined angle in the circumferential direction with respect to the first surface. As seen in FIG. 5B, the second curved contour C2 is continuously connected without any unevenness in the radial direction.

As seen in a comparison between FIG. 5A and FIG. 5B, the shape of the first curved contour C1 is different from the shape of the second curved contour C2. Since the shapes of the first curved contour C1 and the second curved contour C2 are different as described above, the natural frequency of the portion corresponding to the first curved contour C1 and the natural frequency of the portion corresponding to the second curved contour C2 differ in the sub dome 24, making the resonance frequency of the sub dome 24 more easily dispersed.

Since a plurality of first curved contours C1 are located at the cross sections A-A in FIG. 3, they are located at intervals of 120 degrees in the circumferential direction of the sub dome 24. Similarly, since a plurality of the second curved contours C2 are located at the cross sections B-B in FIG. 3, they are located at intervals of 120 degrees in the circumferential direction of the sub dome 24. The first curved contours C1 and the second curved contours C2 are connected by a curved surface that forms the surface of the sub dome 24 (see FIG. 4). Since the first curved contours C1 and the second curved contours C2 are smoothly connected by the curved surface in this manner, the natural frequency changes for each portion of the sub dome 24, and thus the resonance frequency of the diaphragm 16 is further dispersed, and as a result, the occurrence of peaks and dips can be suppressed.

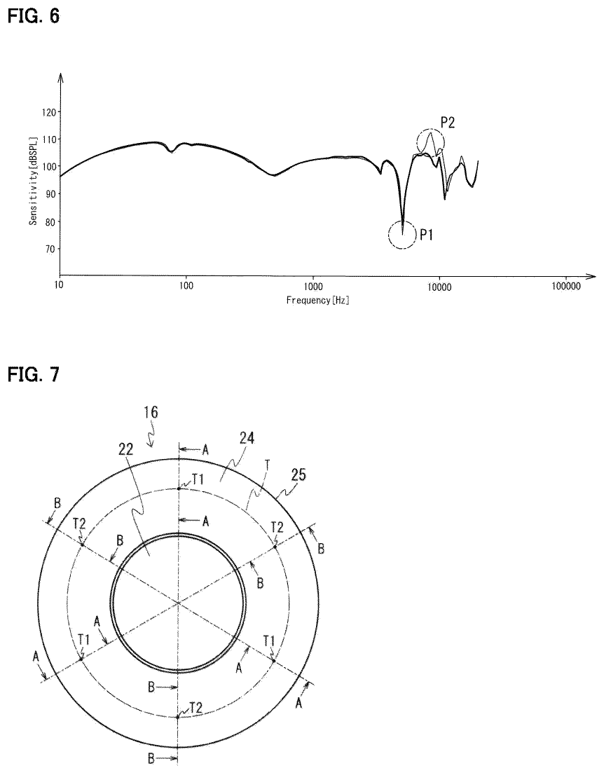

FIG. 6 is an explanatory view for explaining the effects of the shape of the sub dome 24. In FIG. 6, a dotted line indicates frequency characteristics of a comparative example, and a solid line indicates frequency characteristics of the first embodiment. The comparative example differs from the sub dome 24 of the present embodiment in that the positions of the vertices of the sub dome in the radial direction are the same and the positions of the vertices in the height direction are also the same. In this case, it can be seen that peaks and dips occur in the high frequency ranges enclosed by circles P1 and P2 in FIG. 6. On the other hand, in the case of the sub dome 24 of the first embodiment, it is clear that peaks and dips in the high frequency range are suppressed as compared to the case of the comparative example. In addition, in the case of the first embodiment, since no sound absorbing material or acoustic resistance material is used, and no material with high internal loss is used for the diaphragm 16, no negative effects, such as deterioration of sound quality, occur. As a result, in the case of the first embodiment, it is possible to suppress the occurrence of peaks and dips in the high frequency range due to the divided vibrations, without deterioration of sound quality.

### Second Embodiment

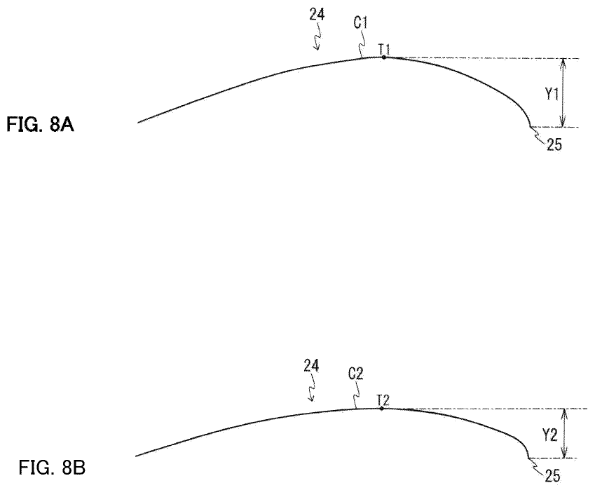

A detailed configuration of a sub dome 24 according to a second embodiment will be described with reference to FIGS. 7, 8A and 8B.

FIG. 7 is a schematic view for explaining the configuration of a diaphragm 16 according to the second embodiment. FIGS. 8A and 8B are each a schematic view for explaining a cross-sectional configuration of a sub dome 24 according to the second embodiment. FIG. 8A shows a schematic configuration of a cross section A-A of FIG. 7, and FIG. 8B shows a schematic configuration of a cross section B-B of FIG. 7.

In a similar manner as with the sub dome 24 of the first embodiment described above, the sub dome 24 of the second embodiment is also formed to extend all the way around the outside of the main dome 22, and the surface of the sub dome 24 is smoothly connected in the circumferential direction (with no portions of steep unevenness on the surface).

In FIG. 7, the vertices of the sub dome 24 are indicated by a dashed line T. As seen in FIG. 7, the positions of the vertices in the radial direction, indicated by the dashed line T, are the same in the circumferential direction. That is, the distance from the outer peripheral edge 25 to each vertex indicated by the dashed line T of the sub dome 24 is the same. On the other hand, the heights of the vertices indicated by the dashed line T are different in the circumferential direction.

Among the vertices of the sub dome 24, a first vertex T1 is at the highest position in the height direction, and a second vertex T2 is at the lowest position in the height direction. Specifically, the height from the outer peripheral edge 25 to the first vertex T1 is Y1, as shown in FIG. 8A, and the height from the outer peripheral edge 25 to the second vertex T2 is Y2, as shown in FIG. 8B. In this way, the sub dome 24 has a plurality of first vertices T1 and second vertices T2, each at different positions in the height direction. The first vertices T1 and the second vertices T2 of the sub dome 24 are alternately located at intervals of 60 degrees in the circumferential direction.

The the heights of the vertices between the first vertex T1 and the second vertex T2 in the height direction continuously change along the circumferential direction, and are greater than Y2 and less than Y1. Since the sub dome 24 has the plurality of vertices with different heights as described above, the cross-sectional configuration of the sub dome 24 changes along the circumferential direction, causing the natural frequency to vary across different portions of the sub dome 24, which disperses the resonance frequency of the sub dome 24. Consequently, the occurrence of peaks and dips in the high frequency range of the sub dome 24 can be suppressed.

The first vertex T1 of the sub dome 24 is located on the first curved contour C1 as shown in FIG. 8A, and the second vertex T2 is located on the second curved contour C2 as shown in FIG. 8B. Since a plurality of first curved contours C1 are located at the cross sections A-A in FIG. 7, they are located at intervals of 120 degrees in the circumferential direction of the sub dome 24. Similarly, since a plurality of second curved contours C2 are located at the cross sections B-B in FIG. 7, they are located at intervals of 120 degrees in the circumferential direction. The first curved contours C1 and the second curved contours C2 of the sub dome 24 are connected by a curved surface that forms the surface of the sub dome 24.

In the case of the second embodiment, peaks and dips in the high frequency range are suppressed in a manner similar to that of the first embodiment (see FIG. 6). In addition, the material of the sub dome 24 of the second embodiment is the same as the material of the sub dome 24 of the first embodiment. Since the design does not require the use of sound absorbing materials or acoustic resistance materials, or materials with high internal loss for the diaphragm 16, no negative effects, such as deterioration of sound quality, occur. As a result, in the second embodiment, it is possible to suppress the occurrence of peaks and dips due to the divided vibrations, without deterioration of sound quality.

### Third Embodiment

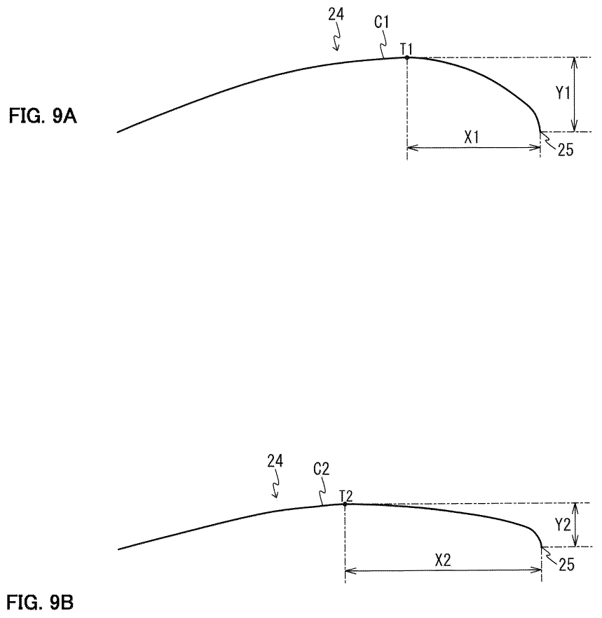

A detailed configuration of a sub dome 24 according to the third embodiment will be described with reference to FIGS. 9A and 9B.

FIGS. 9A and 9B are each a schematic view for explaining a cross-sectional configuration of the sub dome 24 according to the third embodiment. FIG. 9A shows a first curved contour C1 of the sub dome 24, and FIG. 9B shows a second curved contour C2 of the sub dome 24. The first curved contour C1 is the contour of the sub dome 24 at each position of the cross section A-A in FIG. 3, and the second curved contour C2 is the contour of the sub dome 24 at each position of the cross section B-B in FIG. 3. Therefore, the first curved contours C1 are located at intervals of 120 degrees in the circumferential direction, and the second curved contours C2 are also located at intervals of 120 degrees in the circumferential direction.

Similarly to the sub dome 24 of the first embodiment shown in FIG. 4, the surface of the sub dome 24 of the third embodiment is smoothly connected in the circumferential direction, and there are no portions of steep unevenness on the surface. A first vertex T1 and a second vertex T2 of the sub dome 24 of the third embodiment are a combination of the first vertex T1 and the second vertex T2 of the first embodiment and the first vertex T1 and the second vertex T2 of the second embodiment.

The first vertex T1 is located on the first curved contour C1 as shown in FIG. 9A, and the second vertex T2 is located on the second curved contour C2 as shown in FIG. 9B. Therefore, a plurality of first vertices T1 and second vertices T2 are alternately located at intervals of 60 degrees in the circumferential direction.

In the third embodiment, as shown in FIG. 9A and FIG. 9B, the distance from the outer peripheral edge 25 to the first vertex T1 of the sub dome 24 is different from the distance from the outer peripheral edge 25 to the second vertex T2, and the position of the first vertex T1 in the height direction is different from the position of the second vertex T2 in the height direction.

The distance from the outer peripheral edge 25 to the first vertex T1 is less than the distance from the outer peripheral edge to the second vertex T2, and the position of the first vertex T1 in the height direction is higher than the position of the second vertex T2 in the height direction. Specifically, the first vertex T1 among the vertices of the sub dome 24 is closest to the outer peripheral edge 25 of the sub dome 24 in the radial direction and is at the highest position in the height direction. On the other hand, the second vertex T2 is farthest from the outer peripheral edge 25 of the sub dome 24 in the radial direction and is at the lowest position in the height direction.

In the case of the third embodiment, since (i) the distances from the outer peripheral edge 25 to the first vertices T1 and the second vertices T2 are different and (ii) the positions of the first vertices T1 and the second vertices T2 in the height direction also differ, the surface of the sub dome 24 forms a more complicated curved surface, enabling more effective suppression of peaks and dips in the high frequency range compared to the first and second embodiments.

### Fourth Embodiment

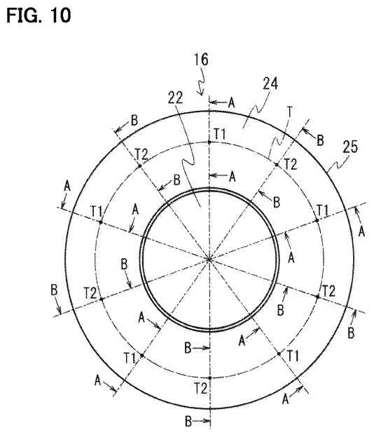

A detailed configuration of a sub dome 24 according to a fourth embodiment will be described with reference to FIG. 10.

FIG. 10 is a schematic view for explaining a configuration of a diaphragm 16 according to the fourth embodiment. In the first to third embodiments described above, the first curved contours C1 in which the first vertices T1 are located and the second curved contours C2 in which the second vertices T2 are located are located at intervals of 120 degrees in the circumferential direction. On the other hand, the fourth embodiment is different in that intervals of a plurality of first curved contours C1 and a second curved contours C2 are less than the intervals of 120 degrees.

Since the first curved contours C1 according to the fourth embodiment are located on the cross sections A-A in FIG. 10, the first curved contours C1 are spaced apart by 72 degrees in the circumferential direction of the sub dome 24. In addition, since the second curved contours C2 are located at the cross sections B-B in FIG. 10, the second curved contours C2 are spaced apart by 72 degrees in the circumferential direction of the sub dome 24. Therefore, the number of first vertices T1 and second vertices T2 is five each.

From the first to fourth embodiments, it is desirable that the number of first vertices T1 and the number of second vertices T2 are each greater than two and odd. When the number of first vertex T1 and second vertex T2 is odd as described above, it is possible to suppress the occurrence of an abnormal vibration mode in a low frequency range due to rolling (rattling) when the diaphragm 16 vibrates, as compared to the case where the number of first vertices T1 and second vertices T2 is even (specifically, two).

More preferably, the number of the first vertices T1 and the number of second vertices T2 are each three or five. This is because when the number of first vertices T1 and second vertices T2 is seven or more, the first vertex T1 and the second vertex T2 approach each other, and a range of the curved surface between the first vertex T1 and the second vertex T2 becomes narrow.

In the above description, the number of first vertices T1 and the number of second vertices T2 are each given as three or five, but it is not limited thereto. For example, the number of first vertices T1 and second vertices T2 may each be four.

### Effects of the Embodiment

The sub dome 24 of the electroacoustic transducer 10 of the present embodiment described above has a plurality of first vertices T1 and a plurality of second vertices T2, which differ in at least one of (i) the distance from the outer peripheral edge 25 in the radial direction and (ii) the position in the height direction, and are located at predetermined intervals in the circumferential direction. The plurality of first vertices T1 and the plurality of second vertices T2 are located on the annular curved surface that is continuous in the circumferential direction. Since the distances from the outer peripheral edge 25 to the vertices of the sub dome 24 and their positions in the height direction are factors that determine the resonance frequency and the divided vibration mode of the sub dome 24, by forming the sub dome 24 into a shape such that the first vertices T1 and the second vertices T2, which are located on the surface, differ in at least one of (i) the distance from the outer peripheral edge 25 or (ii) the position in the height direction, the natural frequency across different portions of the sub dome 24 changes, which causes the resonance frequency to become dispersed. As a result, it is possible to suppress the occurrence of peaks and dips in the high frequency range due to the divided vibrations, without deterioration of sound quality.

The present disclosure is explained on the basis of the exemplary embodiments. The technical scope of the present disclosure is not limited to the scope explained in the above embodiments and it is possible to make various changes and modifications within the scope of the disclosure. For example, all or part the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

What is claimed is:

1. An electroacoustic transducer comprising:
a diaphragm that has a main dome disposed on a central part, and a sub dome that annularly surrounds the main dome, with inner and outer circumferences each forming a circle of a predetermined radius;
a support part that fixedly supports an outer peripheral edge of the sub dome; and
a voice coil that is provided on a back side of the diaphragm and vibrates the diaphragm, wherein
the sub dome has a plurality of first vertices and a plurality of second vertices, which differ in at least one of (i) a distance from the outer peripheral edge in a radial direction and (ii) a position in a height direction, and are located at predetermined intervals in a circumferential direction, and
the plurality of first vertices and the plurality of second vertices are located on an annular curved surface that is continuous in the circumferential direction.

2. The electroacoustic transducer according to claim 1, wherein
a distance from the outer peripheral edge to the first vertex is different from a distance from the outer peripheral edge to the second vertex, and
a position of the first vertex in the height direction is different from a position of the second vertex in the height direction.

3. The electroacoustic transducer according to claim 2, wherein
the distance from the outer peripheral edge to the first vertex is less than the distance from the outer peripheral edge to the second vertex, and
the position of the first vertex in the height direction is higher than the position of the second vertex in the height direction.

4. The electroacoustic transducer according to claim 1, wherein
a first curved contour of a first cross section, which includes the first vertex and is obtained by cutting the sub dome along a first plane that is parallel to the radial direction and the height direction, is connected by the curved surface to
a second curved contour of a second cross section, which includes the second vertex and is obtained by cutting the sub dome along a second plane that is parallel to the radial direction and the height direction.

5. The electroacoustic transducer according to claim 1, wherein
the number of first vertices and the number of second vertices are each greater than two and odd.

6. The electroacoustic transducer according to claim 4, wherein
each of the first vertices is located on the first curved contour of the first cross section at intervals of 120 degrees in the circumferential direction, and
each of the second vertices is located on the second curved contour of the second cross section at intervals of 120 degrees in the circumferential direction.

7. The electroacoustic transducer according to claim 1, wherein
the first vertices and the second vertices are alternately located at equal angular intervals in the circumferential direction.

8. The electroacoustic transducer according to claim 1, wherein
the first vertex is a vertex located at the shortest first distance from the outer peripheral edge, the second vertex is a vertex located at the longest second distance from the outer peripheral edge, and
a plurality of vertices between the first vertex and the second vertex in the circumferential direction have distances greater than the first distance and less than the second distance, and are located so that distances from the outer peripheral edge continuously change along the circumferential direction.

9. The electroacoustic transducer according to claim 1, wherein
the first vertex is a vertex located at the highest first height in the height direction,
the second vertex is a vertex located at the lowest second height in the height direction, and
a plurality of vertices between the first vertex and the second vertex in the circumferential direction have heights higher than the second height and lower than the first height, and are located so that heights continuously change along the circumferential direction.

10. A headphone comprising the electroacoustic transducer according to claim 1.
